(19) United States
(12) Patent Application Publication
(10) Pub. No.: US 2012/0049432 A1
(43) Pub. Date: Mar. 1, 2012

(54) DIGITAL PRINTING SIGNATURE PRODUCTION SYSTEM AND METHOD OF PRODUCING DIGITAL PRINTING SIGNATURE

(75) Inventors: Noboru Fujio, Tokyo (JP); Hisashi Goto, Ebina-shi (JP)

(73) Assignee: KABUSHIKI KAISHA TOKYO KIKAI SEISAKUSHO, Tokyo (JP)

(21) Appl. No.: 13/178,229

(22) Filed: Jul. 7, 2011

(30) Foreign Application Priority Data
Aug. 26, 2010 (JP) 2010-189389

(51) Int. Cl. B41F 13/56

(52) U.S. Cl. 270/20.1

(57) ABSTRACT

A digital printing signature production system S comprises: a plurality of digital printing devices D1, D2, D3, and D4, each of the plurality of digital printing devices D1, D2, D3, and D4 including a paper feeding unit 1 configured to supply a continuous paper and digital printing units 3 and 4 configured to perform printing on the continuous paper supplied from the paper feeding unit 1; a continuous paper guide unit L configured to cause printing-completed continuous papers W1, W2, W3, and W4 fed from the plurality of digital printing devices D1, D2, D3, and D4 and each having different content printed thereon to be overlapped such that width direction edges of the printing-completed continuous papers W1, W2, W3, and W4 are aligned, thereby forming a single continuous paper group Wg; and a single folding unit F configured such that the single continuous paper group Wg is guided into the single folding unit F to produce a signature.

### CROSS-REFERENCE TO RELATED APPLICATIONS

The present application relates to subject matter contained in Japanese Patent Application No. 2010-189389, filed on Aug. 26, 2010, all of which is expressly incorporated herein by reference in its entirety.

### BACKGROUND OF THE INVENTION

1. Field of the Invention

The present invention relates to: a digital printing signature production system configured to produce a signature, configured by a plurality of sheets, from a continuous paper printed by a digital printing unit; and a method of producing a digital printing signature.

2. Description of the Related Art

In a rotary printing press, the number of pages having different content that are capable of being printed in a continuity direction of a continuous paper is limited by the circumference of the plate mountable on the plate cylinder. However, digital printing, unlike the rotary printing press, does not require plates, hence in digital printing there is no limit to the number of pages having different content that are capable of being printed in the continuity direction of a single continuous paper. Therefore, when producing a signature configured from sheets on which a plurality of pages having different content are printed, pages on which required content is printed are printed on the continuous paper in a previously determined sequence, the printed continuous paper is cut to form sheets and those sheets are stacked and folded, whereby it is possible to produce a signature configured from a plurality of sheets on which different content is printed.

For example, newspaper production apparatuses employing ink jet printing and having the purpose of producing a newspaper signature are proposed by Patent Documents 1 and 2 identified below.

Newspaper signature production disclosed in Patent Document 1 includes (1) a receiving element such as a grasping device, a sucker, etc. receiving sheet by sheet, from a conveyor, sheets of paper cut out from a continuous paper on which digital printing such as ink jet printing, etc. has been performed, and carrying the sheets sequentially into a collecting station, (2) stacking the sheets one upon another in the collecting station, (3) discharging a stack of a certain number of sheets from the collecting station, (4) continuously carrying a subsequent series of printed sheets one by one into the collecting station from which the stack has been discharged, (5) carrying the stack discharged from the collecting station into a folding station, and (6) folding the stack in the folding station and outputting the stack from the folding station. The steps (1) to (6) are performed sequentially by the respective stations.

Newspaper signature production disclosed in Patent Document 2 is approximately the same as that disclosed in Patent Document 1. To be specific, Patent Document 2 is different from Patent Document 1 in disclosing that after a printed continuous paper is dried, it is divided into two pieces in parallel with the continuity direction, and in disclosing as to the steps (1) and (2) that a delivery fan mechanism which rotates intermittently is provided in the collecting station, and sheets of paper cut out from a continuous paper on which digital printing has been performed are discharged toward the blades of the delivery fan maintained horizontally so that the sheets are stacked, or that sheets of paper cut out from a continuous paper on which digital printing has been performed are sequentially inserted into between respective blades of a continuously rotating delivery fan having many blades arranged in a circumferential direction, and then a stripper shoe lets the sheets of paper fall from between the blades onto a conveyor so that the sheets are stacked.

[Patent Document 1] JP 2002-193545 A

[Patent Document 2] JP 2003-341927 A

### SUMMARY OF THE INVENTION

By the way, in a conventional digital printing signature production system such as represented by the above-listed Patent Documents 1 and 2, content of multiple sheets configuring the signature is printed on a single continuous paper and, in the folding unit, the printed continuous paper is cut to form the sheets and those sheets are stacked aligning the edges of the sheets, and folded to form the signature. Consequently, there is a problem that although printing is performed continuously on the continuous paper by the digital printing unit, it is only after first waiting for all of the sheets configuring the signature to be stacked and then folding those sheets that a single signature is finally completed. As a result, the larger the number of sheets configuring the signature, the longer the time taken to produce the signature.

Furthermore, there is a problem that, first, the printed sheets have their movement in a running direction (horizontal direction) stopped, whereupon the printed sheets are stacked in a vertical direction at a certain position to prevent misalignment, thereby forming a stack of sheets configuring the signature; then, the stack of sheets is moved in the horizontal direction again, toward the folding mechanism, by a conveyor means. As a result, movement of the sheets is discontinuous hence operation at high speed is difficult, so that again a long time is taken to produce the signature.

The present invention was made in view of the above-mentioned problems, and an object of the present invention is to provide a digital printing signature production system and a method of producing a digital printing signature that are capable of producing a signature, configured from a plurality of sheets, by digital printing having no need of plates, in a short time, by over lapping the sheets configuring the signature speedily and with good precision.

A digital printing signature production system according to the present invention comprises: a plurality of digital printing devices, each of the plurality of digital printing devices including a paper feeding unit configured to supply a continuous paper and a digital printing unit configured to perform printing on the continuous paper supplied from the paper feeding unit; a continuous paper guide unit configured to cause printing-completed continuous papers fed from the plurality of digital printing devices and each having different content printed thereon to be overlapped such that width direction edges of the printing-completed continuous papers are aligned, thereby forming a single continuous paper group; and a single folding unit configured such that the single continuous paper group is guided into the single folding unit to produce a signature.

Moreover, a method of producing a digital printing signature according to the present invention, the method configured to produce a signature by a plurality of digital printing devices, each of the digital printing devices comprising a folding unit and a digital printing unit, comprises: guiding continuous papers individually into each of the plurality of digital printing devices to print different content on each of the guided continuous papers by each of the digital printing devices; overlapping a plurality of printing-completed continuous papers such that width direction edges of the printing-completed continuous papers are aligned; and guiding the overlapped plurality of printing-completed continuous papers into the folding unit to undergo cutting and folding.

The present invention has the advantages of digital printing that, when printing content is changed, there is no need for an operation to stop the printing device to exchange plates or an operation to adjust the amount of ink, etc. required for printing according to the design of the plates, and moreover the present invention aligns the plurality of sheets configuring the signature at one time. Hence, the present invention allows the signature to be produced in a short time. In addition, the present invention matches the edges of paper to overlap the paper in a continuous paper state, and the overlapped continuous paper is cut in a direction perpendicular to the running direction to perform a lateral fold. Hence, stacking of the plurality of sheets configuring the signature is reliable and there is no misalignment. Furthermore, in the present invention, when the sheets configuring the signature are stacked, there is no stopping of movement of the sheets in the running direction. Hence, the present invention allows production of the signature to be performed speedily.

### BRIEF DESCRIPTION OF THE DRAWINGS

FIG. 1 is a plan view of a first embodiment of a digital printing signature production system according to the present embodiment as viewed from above.

FIG. 2 is a cross-sectional view taken along the line A-A of FIG. 1 and viewed in the direction of the arrows showing an inside front elevation view of a printing device and a folding unit.

FIG. 3 is a view taken along the line B-B of FIG. 1 and viewed in the direction of the arrows showing a side view of a continuous paper guide unit and the folding unit.

FIG. 4 is a perspective view of a sheet group Pg in which stacking of sheets is shown displaced in order to show a configuration of the sheet group Pg in an easily understandable manner.

FIG. 5 is a perspective view of a signature Ps.

FIG. 6 is a plan view of apart of a second embodiment of the digital printing signature production system according to the present embodiment as viewed from above.

FIG. 7 is a side view of a part of a continuous paper guide unit of FIG. 6 as viewed from a direction of the arrow Z in FIG. 6.

FIG. 8 is a side view showing one of various embodiments that maybe adopted by the digital printing signature production system according to the present invention.

FIG. 9 is a side view showing an embodiment separate to the one in FIG. 8 that may be adopted by the digital printing signature production system according to the present invention.

### DETAILED DESCRIPTION OF THE INVENTION

Preferred embodiments for carrying out the present invention are described below with reference to the drawings. The following embodiments are not intended to limit the inventions set forth in the claims, and the combinations of features described in the embodiments are not all necessarily indispensable for the means for solving the problem provided by the invention.

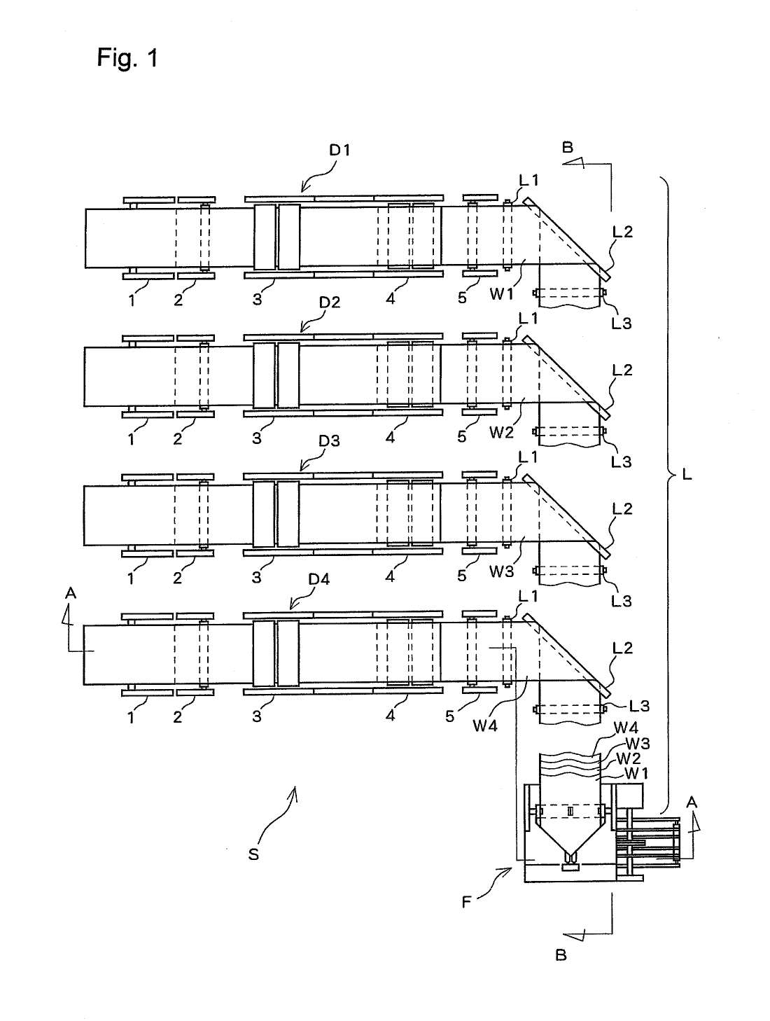

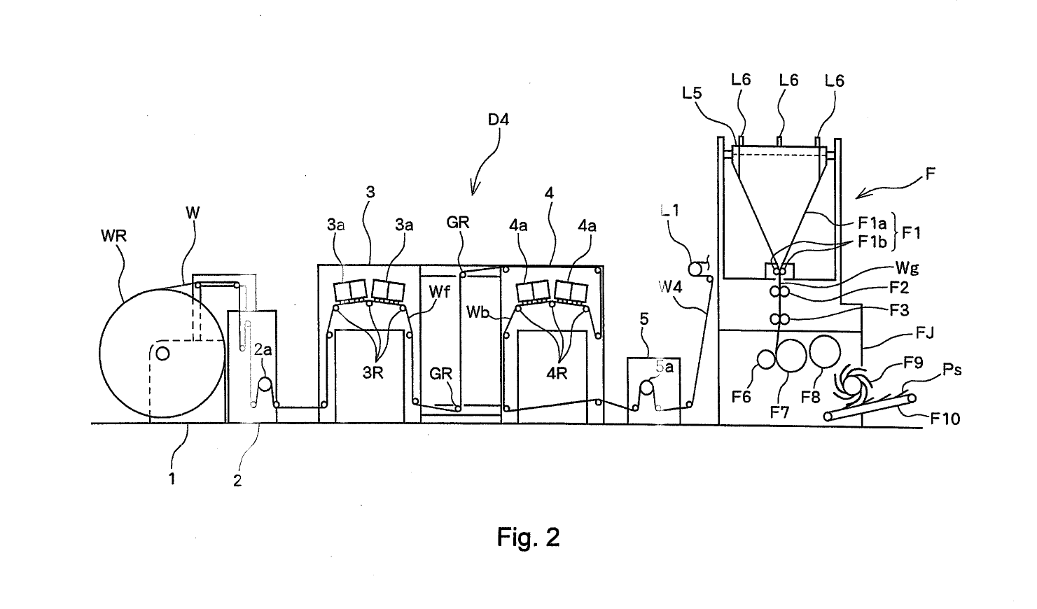

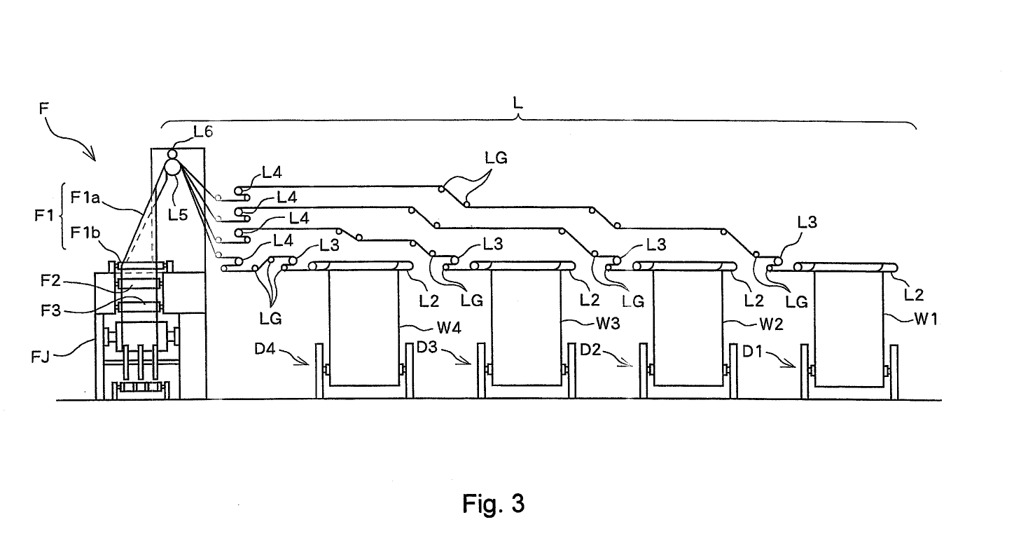

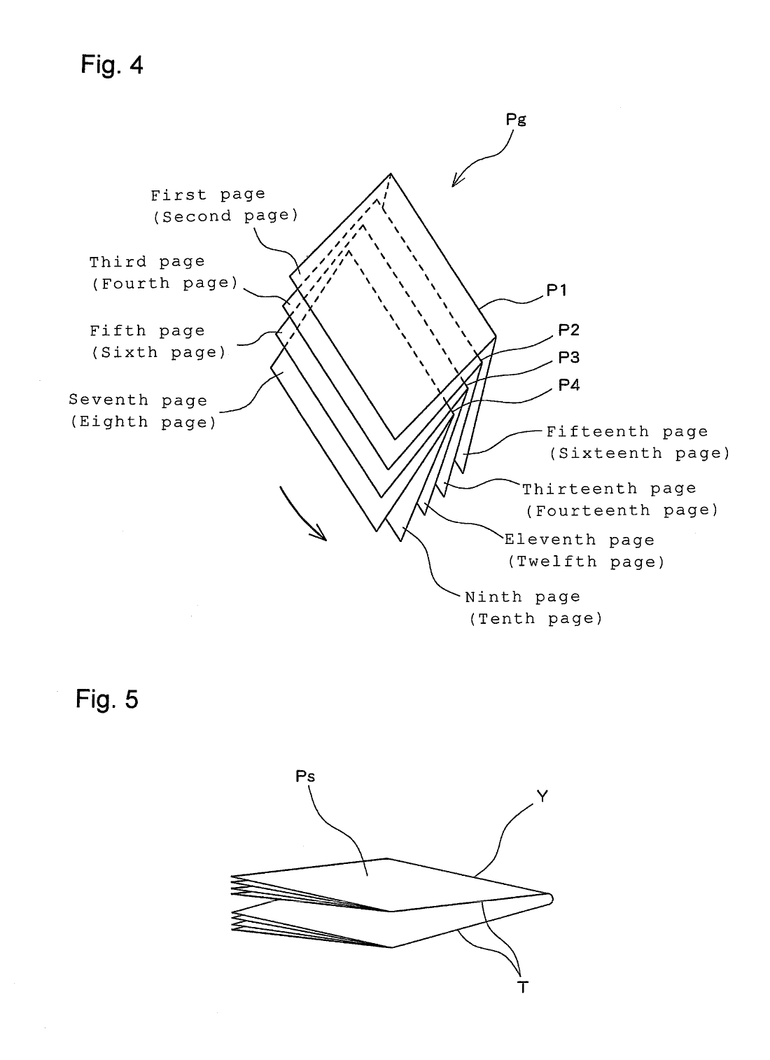

FIG. 1 is a plan view showing a first embodiment of a digital printing signature production system according to the present embodiment. FIG. 2 is a cross-sectional view taken along the line A-A of FIG. 1 and viewed in the direction of the arrows showing an inside front elevation view of a fourth digital printing device D4 and a folding unit F. FIG. 3 is a view taken along the line B-B of FIG. 1 and viewed in the direction of the arrows showing a side view of a continuous paper guide unit L and the folding unit F. FIG. 4 is a perspective view showing a sheet group Pg on a cylinder surface of a folding cylinder F7, the sheet group Pg obtained by cutting a continuous paper group Wg. In FIG. 4, the sheet group Pg is shown upright and stacking of sheets is shown displaced in order to show a configuration of the sheet group Pg in an easily understandable manner. Note that in FIG. 4, the arrow indicates an advancement direction of the sheet group Pg, and the page shown in brackets indicates a page on a reverse side to that shown. FIG. 5 is a perspective view showing folds of a signature Ps in an easily understandable manner. Note that T indicates a longitudinal folding portion and Y indicates a lateral folding portion. Furthermore, in FIG. 1, guide rollers for guiding a continuous paper are not shown. In addition, driving means of rotary driven types of roller are omitted from all drawings.

A digital printing signature production system S is configured by: a first digital printing device D1, a second digital printing device D2, a third digital printing device D3, and the fourth digital printing device D4; the continuous paper guide unit L configured to guide printing-completed continuous papers W1, W2, W3, and W4 printed by the four digital printing devices into a single folding unit F; and the single folding unit F.

Configurations of the first through fourth digital printing devices D1, D2, D3, and D4 are the same, hence their configurations are described with reference to FIG. 2, taking as an example the fourth digital printing device D4.

The fourth digital printing device D4 includes, from a left side of the page in FIG. 2, a paper feeding unit 1, an in-feed unit 2, two ink jet printing units 3 and 4 that are digital printing units, an out-feed unit 5, and a plurality of guide rollers GR disposed at appropriate positions and configured to guide a continuous paper W.

The paper feeding unit 1 supports a paper roll WR and feeds the continuous paper W from the paper roll WR.

The in-feed unit 2 sends forth the continuous paper W to the following ink jet printing unit 3 while tensioning the continuous paper W by means of an in-feed roller 2a which is rotary driven.

The first ink jet printing unit 3 includes an ink jet head unit 3a configured from a plurality of ink jet heads, and prints on a front surface Wf of the continuous paper W by the continuous paper W being guided by a plurality of guide rollers 3R to run in a direction from left to right of the page in FIG. 2.

The continuous paper W of which the front surface Wf has been printed by the first ink jet printing unit 3 is guided by the guide rollers GR to be introduced to the second ink jet printing unit 4.

The second ink jet printing unit 4 also includes an ink jet head unit 4a configured from a plurality of ink jet heads, and prints on a back surface Wb of the continuous paper W by the continuous paper W being guided by a plurality of guide rollers 4R to run in a direction from right to left of the page in FIG. 2.

The out-feed unit 5 tensions the continuous paper W running through the ink jet printing units 3 and 4 in cooperation with the in-feed unit 2, by means of an out-feed roller 5a which is rotary driven, and also sends forth the printing-completed continuous paper W4 produced having both sides printed in a desired manner from the fourth digital printing device D4 to the continuous paper guide unit L.

Similarly, the third digital printing device D3, the second digital printing device D2, and the first digital printing device D1 produce the printing-completed continuous paper W3, the printing-completed continuous paper W2, and the printing-completed continuous paper W1, respectively, and send forth these printing-completed continuous papers W3, W2, and W1 to the continuous paper guide unit L.

Next, a configuration of the continuous paper guide unit L is described with reference to FIGS. 1 and 3. The continuous paper guide unit L is configured, with respect to each of the printing-completed continuous papers W1-W4, to include: a paper drawing roller L1 which is rotary driven; an angle bar L2; paper drawing rollers L3 and L4 which are rotary driven; and a plurality of guide rollers LG disposed at appropriate positions, and also to include: a single roller top of former (RTF) L5 which is attached to an upper portion of the folding unit F and is rotary driven; a trolley L6 which presses the printing-completed continuous papers W1-W4 onto a circumferential surface of the roller top of former (RTF) L5; and a structure, not shown, for supporting the paper drawing roller L1, the angle bar L2, the paper drawing rollers L3 and L4, and the guide rollers LG.

Each of the paper drawing rollers L1 draws the printing-completed continuous papers W1-W4 sent forth from the out-feed unit 5 and guides the printing-completed continuous papers W1-W4 into an entrance of the angle bar L2.

The angle bar L2 changes the running direction of the printing-completed continuous papers W1-W4 by 90 degrees horizontally thereby directing the printing-completed continuous papers W1-W4 toward the folding unit F, and, when the printing-completed continuous papers W1-W4 are overlapped on the circumferential surface of the roller top of former (RTF) L5, determines a width direction position of the printing-completed continuous papers W1-W4 such that edges of the printing-completed continuous papers W1-W4 are aligned.

The paper drawing roller L3 draws the printing-completed continuous papers W1-W4 of which the running direction has been changed by means of the angle bar 2, and sends forth the printing-completed continuous papers W1-W4 to the paper drawing roller L4.

The paper drawing roller L4 draws the printing-completed continuous papers W1-W4 sent forth from the paper drawing roller L3, and sends forth the printing-completed continuous papers W1-W4 to the roller top of former (RTF) L5.

The roller top of former (RTF) L5 draws the continuous paper group Wg which has the continuous papers W1-W4 overlapped in a state where the width direction position of the edges of the continuous papers W1-W4 are aligned and guides the continuous paper group Wg into the upper portion of the folding unit F by the continuous paper group Wg being wrapped around the circumferential surface of the roller top of former (RTF) L5 and, further, by the continuous paper group Wg being pressed onto the circumferential surface of the roller top of former (RTF) L5 by the trolley L6.

The folding unit F is configured from a former F1, two pairs of nipping rollers F2 and F3, and a jaw device FJ.

The former F1 folds the continuous paper group Wg in half parallel to the continuity direction of the continuous paper group Wg (longitudinal folding), by means of a former board F1a and a pair of forming rollers F1b and F1b. The longitudinally folded continuous paper group Wg proceeds downward in a vertical direction to be guided toward the nipping roller F2.

The nipping rollers F2 and F3 each nip the continuous paper group Wg by roller pairs which are respectively rotary driven thereby making the fold folded by the former F1 complete, and send forth the continuous paper group Wg to the jaw device FJ.

The jaw device FJ includes a cutting cylinder F6, a folding cylinder F7, a jaw cylinder F8, a delivery fan F9, and a conveyor F10 which are each rotary driven. The jaw device FJ cuts the continuous paper group Wg to a previously determined length in a direction perpendicular to the running direction of the continuous paper group Wg to form the sheet group Pg, furthermore, folds the sheet group Pg in half parallel to the cutting direction (lateral folding) to form the signature Ps, and discharges the signature Ps from the conveyor F10. Note that the jaw device is well-known, hence a detailed description of the jaw device is omitted.

A process for producing a sixteen-page newspaper signature by means of the above-described digital printing signature production system is now described.

The continuous paper W employed herein has a width dimension which is double that of the lateral width of one page of the newspaper to be produced (that is, a width dimension which is a lateral width of a two-page spread of the newspaper).

Pages, each different, are printed two pages at a time in the width direction of the front surface and the back surface of the continuous paper W, that is, four pages on both surfaces of the continuous paper W, by each of the first through fourth digital printing devices D1, D2, D3, and D4, this being performed repeatedly in the running direction of the continuous paper W to produce the printing-completed continuous papers W1-W4.

Specifically, a first page and a sixteenth page are printed on the back surface of the printing-completed continuous paper W1, and a second page and a fifteenth page are printed on the front surface of the printing-completed continuous paper W1; a third page and a fourteenth page are printed on the back surface of the printing-completed continuous paper W2, and a fourth page and a thirteenth page are printed on the front surface of the printing-completed continuous paper W2; a fifth page and a twelfth page are printed on the back surface of the printing-completed continuous paper W3, and a sixth page and an eleventh page are printed on the front surface of the printing-completed continuous paper W3; and a seventh page and a tenth page are printed on the back surface of the printing-completed continuous paper W4, and an eighth page and a ninth page are printed on the front surface of the printing-completed continuous paper W4.

The printing-completed continuous papers W1-W4 have their running direction changed by 90 degrees horizontally to be directed toward the folding unit F and have a width direction position of their edges aligned by means of the continuous paper guide unit L.

Furthermore, the printing-completed continuous papers W1-W4, having proceeded through the continuous paper guide unit L, are overlapped on the circumferential surface of the roller top of former (RTF) L5 attached to the upper portion of the folding unit F in a state where respective edges of the printing-completed continuous papers W1-W4 are aligned. The printing-completed continuous papers W1-W4 are overlapped on the circumferential surface of the roller top of former (RTF) L5 to become the continuous paper group Wg, and sent forth as one to the former F1 of the folding unit F by being pressed onto the circumferential surface of the roller top of former (RTF) L5 by the trolley L6.

The continuous paper group Wg folded in half parallel to the running direction (longitudinally folded) by the former F1 has its fold made complete by the nipping rollers F2 and F3, and is introduced to between the cutting cylinder F6 and the folding cylinder F7 of the jaw device FJ, and cut in a direction perpendicular to the running direction to become the sheet group Pg configured from four sheets P1-P4 folded in half (longitudinally folded) by the former F1.

The sheet P1, the sheet P2, the sheet P3, and the sheet P4 configuring the sheet group Pg are cut from, respectively, the printing-completed continuous paper W1, the printing-completed continuous paper W2, the printing-completed continuous paper W3, and the printing-completed continuous paper W4. Pages printed on each of the sheets are as shown in FIG. 4.

When the continuous paper group Wg is cut in the direction perpendicular to the running direction by the cutting cylinder F6 and the folding cylinder F7, print timing of each of the ink jet printing units 3 and 4 in the first through fourth digital printing devices D1, D2, D3, and D4 is adjusted such that positions of each of the pages printed on the printing-completed continuous papers W1-W4 configuring the continuous paper group Wg are aligned, and cut timing of the jaw device FJ is adjusted such that the printing-completed continuous papers W1-W4 are cut at boundary positions between pages. Alternatively, a configuration may be adopted in which a compensator (adjust roller) not shown is provided to each running path of the printing-completed continuous papers W1-W4 in the continuous paper guide unit L, such that, when the continuous paper group Wg is cut in the direction perpendicular to the running direction by the cutting cylinder F6 and the folding cylinder F7, positions of each of the pages printed on the printing-completed continuous papers W1-W4 configuring the continuous paper group Wg are aligned and a running path length of the printing-completed continuous papers W1-W4 is adjusted such that the printing-completed continuous papers W1-W4 are cut at boundary positions between pages.

The sheet group Pg is further folded in half parallel to the cutting direction (lateral folding) by the jaw cylinder F8 to be aligned on and discharged from the conveyor F10 via the delivery fan F9 as the signature Ps (refer to FIG. 5), that is, as the sixteen-page newspaper signature.

A printing device capable of printing a continuous paper having a width that is multiple times the width of a sheet configuring the signature (multiple times the width of a sheet in a state where the fold due to the former is opened out) makes it possible to produce in a short time a signature configured by an even larger number of sheets.

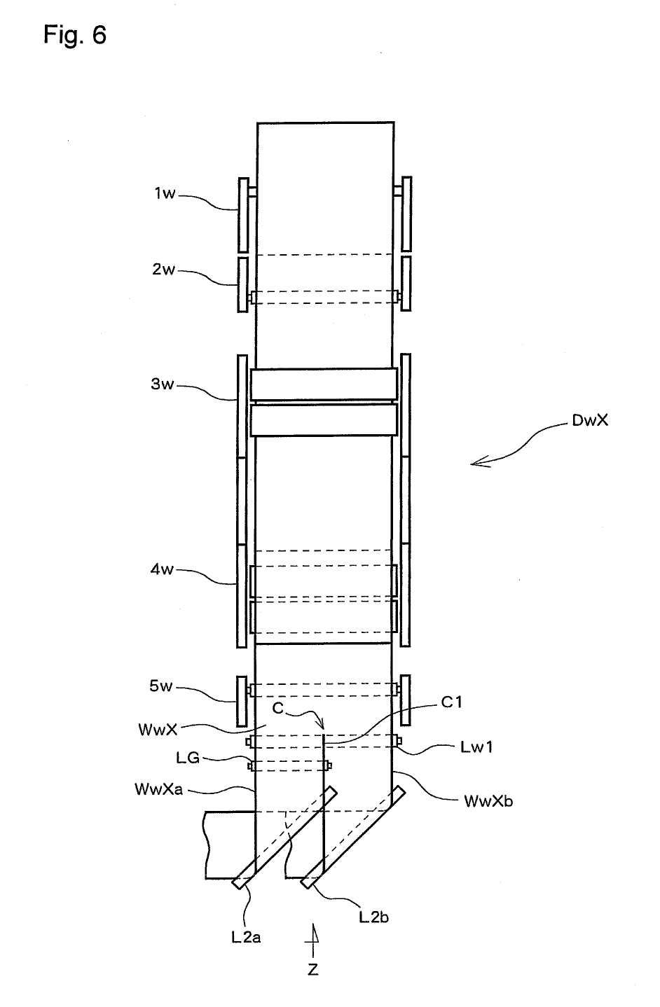

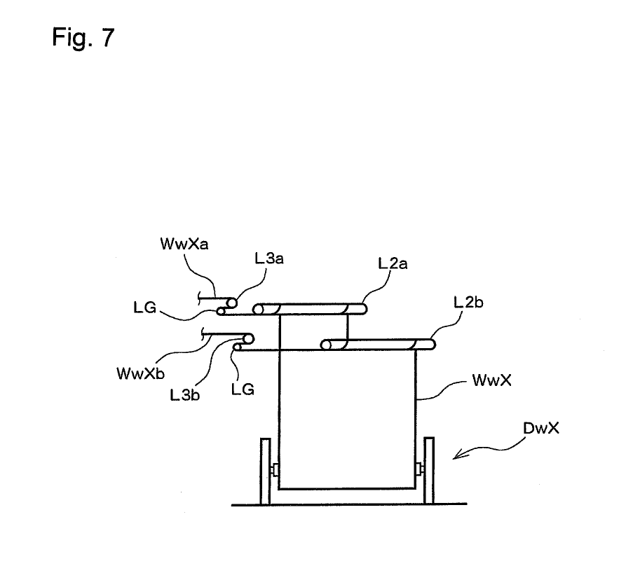

FIG. 6 is a plan view showing a digital printing device DwX and a part of a continuous paper guide unit Lw configuring a second embodiment of the digital printing signature production system according to the present embodiment. FIG. 7 is a side view showing the part of the continuous paper guide unit Lw.

The digital printing device DwX is capable of printing on both surfaces of a continuous paper Ww having a width that is double the width of a sheet configuring the signature (double the width of a sheet in a state where the fold due to the former is opened out), and the part of the continuous paper guide unit Lw cuts a printing-completed continuous paper WwX printed by the digital printing device DwX parallel to the running direction of the printing-completed continuous paper WwX at a center in the width direction of the printing-completed continuous paper WwX to divide the printing-completed continuous paper WwX into printing-completed continuous papers WwXa and WwXb by a slitter device C, changes the running direction of the printing-completed continuous papers WwXa and WwXb by 90 degrees horizontally and aligns the width direction position of sides of the printing-completed continuous papers WwXa and WwXb to direct the printing-completed continuous papers WwXa and WwXb toward a folding unit not shown.

The digital printing device DwX includes a paper feeding unit 1w, an in-feed unit 2w, two ink jet printing units 3w and 4w that are digital printing units, an out-feed unit 5w, and a plurality of guide rollers not shown disposed at appropriate positions and configured to guide the continuous paper Ww.

The paper feeding unit 1w, the in-feed unit 2w, the two ink jet printing units 3w and 4w, the out-feed unit 5w, and the guide rollers GRw have functions which are the same as those of the paper feeding unit 1, the in-feed unit 2, the two ink jet printing units 3 and 4, the out-feed unit 5, and the guide rollers GR in the digital printing devices D1, D2, D3, and D4. The point of difference is that the width of the printed continuous paper Ww is double that of the continuous paper W, and that the aforementioned paper feeding unit 1w, in-feed unit 2w, two ink jet printing units 3w and 4w, out-feed unit 5w, and guide rollers GRw are compatible with the width of the continuous paper Ww.

The part of the continuous paper guide unit Lw is provided with a paper drawing roller Lw1 which is rotary driven, a slitter device C, two angle bars L2a and L2b, paper drawing rollers L3a and L3b which are rotary driven, and the plurality of guide rollers LG disposed at appropriate positions.

The paper drawing roller Lw1 draws the printing-completed continuous paper WwX sent forth from the out-feed unit 5W to an entrance of the angle bars L2a and L2b. The slitter device C positions a rotary driven circular slitter knife C1 at the center in the width direction of the printing-completed continuous paper WwX wrapped around the circumferential surface of the paper drawing roller Lw1, and, moreover, the paper drawing roller Lw1 has a groove of a width slightly broader than a thickness of the slitter knife C1 provided at a position corresponding to a cutting edge (outer circumferential edge) of the slitter knife C1. The printing-completed continuous paper WwX wrapped around the paper drawing roller Lw1 is drawn in the running direction of the printing-completed continuous paper WwX to be cut along its continuity direction by the cutting edge of the slitter knife C1 cutting 1-3 millimeters into the groove of the paper drawing roller Lw1, thereby becoming the printing-completed continuous papers WwXa and WwXb.

The printing-completed continuous paper WwXb sent forth from the paper drawing roller Lw1 is directed toward the angle bar L2b, and the printing-completed continuous paper WwXa sent forth from the paper drawing roller Lw1 has its running direction path changed to diagonally upward of that of the printing-completed continuous paper WwXb by a single guide roller LG to be directed toward the angle bar L2a.

The angle bar L2a changes the running direction of the printing-completed continuous paper WwXa by 90 degrees horizontally, and the angle bar L2b changes the running direction of the printing-completed continuous paper WwXb by 90 degrees horizontally in the same direction as the printing-completed continuous paper WwXa, and, moreover, the angle bars L2a and L2b align the width direction position of sides of the printing-completed continuous papers WwXa and WwXb to direct the printing-completed continuous papers WwXa and WwXb toward the folding unit not shown.

The paper drawing roller L3a draws the printing-completed continuous paper WwXa which has had its running direction changed by the angle bar L2a, and sends forth the printing-completed continuous paper WwXa to a next paper drawing roller not shown. At the same time, the paper drawing roller L3b draws the printing-completed continuous paper WwXb which has had its running direction changed by the angle bar L2b, and sends forth the printing-completed continuous paper WwXb to a next paper drawing roller not shown.

The second embodiment of the digital printing signature production system may be configured as a system in which one or a plurality of the above-mentioned digital printing devices DwX are disposed, the width direction position of sides of the printing-completed continuous papers WwXa and WwXb are aligned and the printing-completed continuous papers WwXa and WwXb are overlapped in the continuous paper guide unit, and the printing-completed continuous papers WwXa and WwXb are guided into a single folding unit similar to that in the first embodiment to produce the signature.

Note that, similarly to in the first embodiment, and in addition to the part of the continuous paper guide unit Lw already mentioned, the continuous paper guide unit may comprise the plurality of guide rollers disposed at appropriate positions, at least one roller top of former (RTF) which is attached to the upper portion of the folding unit and is rotary driven, the trolley which presses the continuous paper onto the circumferential surface of the roller top of former (RTF), and, furthermore, the structure, not shown, for supporting the paper drawing rollers, the angle bars, and the guide rollers.

For example, in the case that the newspaper signature is created adopting a configuration in which four digital printing devices DwX are disposed aligned in the width direction of the continuous paper (aligned in parallel), pages, each different, are printed four pages at a time in the width direction of the front surface and the back surface of the continuous paper Ww, that is, eight pages on both surfaces of the continuous paper W, by each of the digital printing devices DwX, this being performed repeatedly in the running direction of the continuous paper Ww to produce four printing-completed continuous papers WwX. Each of the printing-completed continuous papers WwX is divided into the printing-completed continuous papers WwXa and WwXb by the continuous paper guide unit. The printing-completed continuous papers WwXa and WwXb, on which pages, each different, are printed two pages at a time in the width direction of the front surface and the back surface, that is, four pages on both surfaces, have their running directions changed by 90 degrees horizontally to be directed toward the folding unit and have the width direction position of their sides aligned. By overlapping eight printing-completed continuous papers on which pages, each different, are printed two pages at a time in the width direction of the front surface and the back surface, that is, four pages on both surfaces, in this way, and guiding the eight overlapped printing-completed continuous papers into the folding unit as a continuous paper group, a 32-page newspaper signature can be produced.

Preferred embodiments of the present invention have thus been described, but the technical scope of the present invention is not limited to the scope of description in the above embodiments. Various changes or improvements can be made to the above embodiments.

For example, the above-mentioned first and second embodiments describe producing a newspaper signature. However, the produced signature is not limited to being a newspaper signature.

In addition, the second embodiment of the signature production system enables printing of two sheets configuring a signature to be performed by one digital printing device DwX. Hence, production of a signature configured by a large number of sheets can be achieved by a small number of disposed printing devices.

Moreover, when producing a signature configured by an odd number of sheets, it is only required to perform the following control in at least one of the printing devices. That is, it is only required to control the paper feeding unit in which a paper roll having the same paper width as the width of the sheet can be attached such that one side of the paper roll is aligned with a center of a printing region width of the printing device, and to control the inkjet head unit to perform printing by discharging ink on a surface of the continuous paper supplied from the paper roll having the same paper width as said sheet, whereby a printing-completed continuous paper having the same width as the width of the sheet is produced and guided to the folding unit without using a slitter device in the continuous paper guide unit.

Furthermore, the digital printing signature production system S shown in FIGS. 1 and 3 has a configuration in which four digital printing devices are disposed aligned in the width direction of the continuous paper (aligned in parallel). However, the configuration, number, and disposed position of the digital printing device is not limited to this. The digital printing device need only include at least a paper feeding unit for feeding the continuous paper and a digital printing unit for performing printing on that continuous paper. Moreover, a configuration may be adopted in which an ink drying device or the like is provided.

The digital printing devices may be disposed aligned in a length direction of the continuous paper (aligned in series), or, may be disposed stacked in a vertical direction.

The continuous paper guide unit, provided that it enables the printing-completed continuous paper to be guided into the folding unit overlapped and having width direction sides of the printing-completed continuous paper aligned, may also adopt a variety of modified examples according to the disposed position of the digital printing devices. Furthermore, a configuration maybe adopted in which, in a roller top of former (RTF) unit, a slitter mechanism is added, the center in the width direction of the continuous paper group is cut, and places of longitudinal folding due to the former are detached to form a signature of only lateral folding due to the jaw device.

The configuration of the folding unit is also not limited to the configuration shown in FIG. 2. For example, to match the required form of the signature, the folding unit may adopt a configuration in which a former is not provided and the continuous paper group not subject to longitudinal folding is guided to between the cutting cylinder and the folding cylinder (In this case, the orientation of the folding unit is changed by 90 degrees to match the orientation of the continuous paper group), or may adopt a configuration in which a quarter folding device is added downstream of the jaw device. Moreover, the folding unit is not limited to comprising a jaw device, and may be configured to include a blade folding device or a folding device having a correct function.

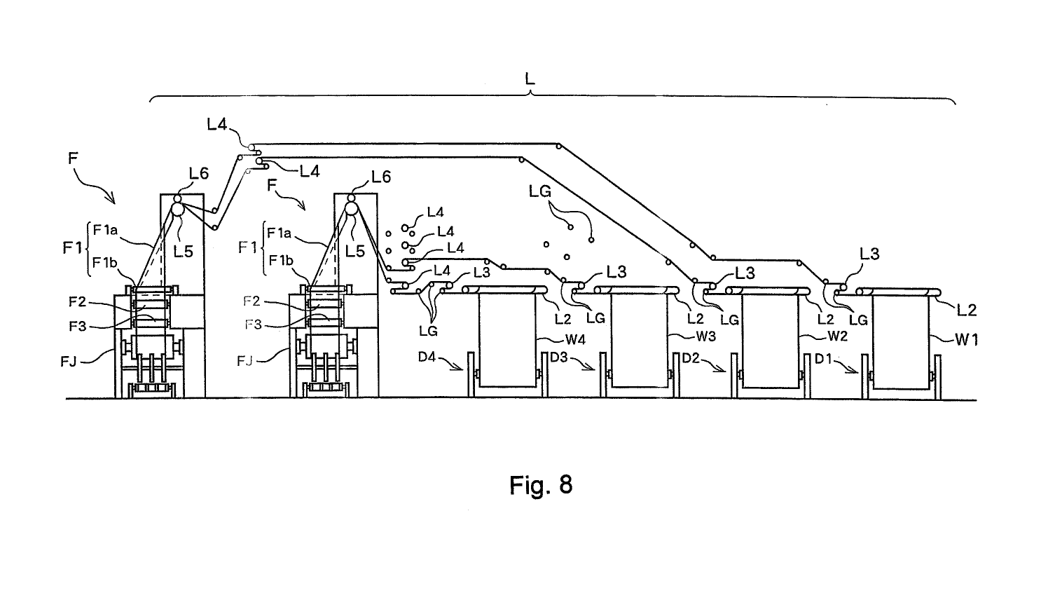

Furthermore, the above-mentioned digital printing signature production system S according to the first and second embodiments illustrates the case where a single folding unit F is provided per one set of the digital printing signature production system S. However, in the digital printing signature production system according to the present invention, a plurality of folding units F may be provided per one set of the digital printing signature production system. For example, FIG. 8 is a side view showing one of various embodiments that may be adopted by the digital printing signature production system according to the present invention, and, as shown in FIG. 8, two folding units F may be jointly provided per one set of the digital printing signature production system. This system is configured such that two folding units F are jointly provided to the four digital printing devices D1, D2, D3, and D4 in a direction parallel to the running direction of the continuous paper group. Hence, a continuous paper group configured from two continuous papers is guided to each of the two folding units F, whereby two kinds of signatures configured from two sheets can be produced.

Note that providing a plurality of folding units F to the digital printing signature production system according to the present invention enables, for example, double or more of the same kind of signature to be produced compared to the above-mentioned first and second embodiments. Furthermore, operating only a portion of the plurality of folding units F provided and suspending operation of the other folding units F enables a desired kind or quantity of signature to be produced.

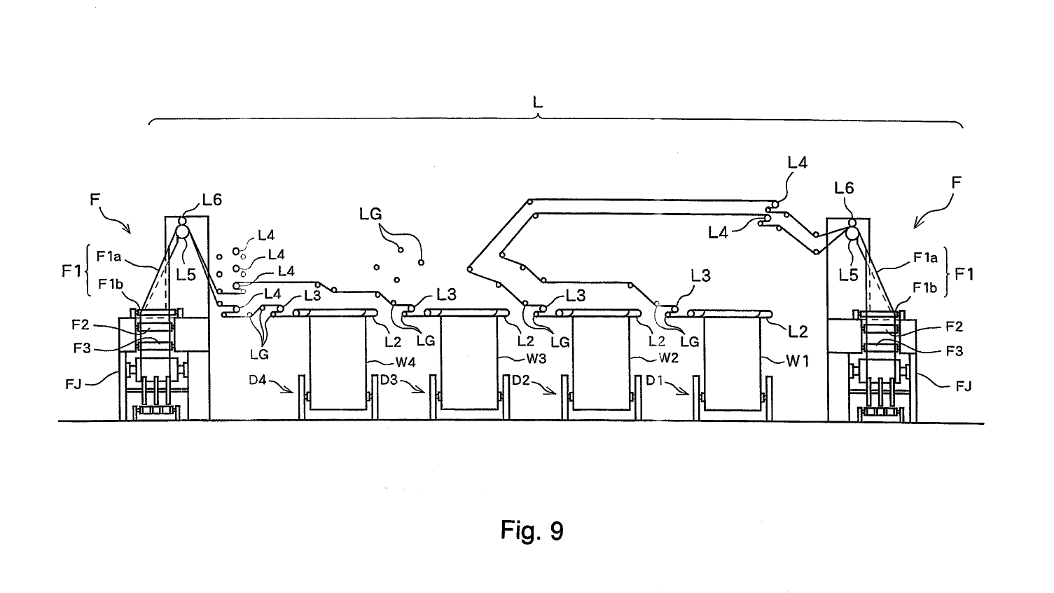

Furthermore, FIG. 8 illustrates the case where two of the folding units F exemplified in FIG. 8 are jointly provided at positions adjacent to each other. However, the position for disposing the plurality of folding units F may be selected as required. For example, as illustrated in FIG. 9, one folding unit F may be provided to each of the two ends of the four digital printing devices D1, D2, D3, and D4, so as to sandwich the digital printing devices D1, D2, D3, and D4. The various embodiments of the invention exemplified in FIGS. 8 and 9 clarify the fact that the digital printing signature production system according to the present invention is an excellent system capable of being realized unhindered by spatial limitations.

It is clear from the descriptions in the claims that embodiments including such changes or improvements can also be included in the technical scope of the present invention.

What is claimed is:

1. A digital printing signature production system, comprising:
a plurality of digital printing devices, each of the plurality of digital printing devices including a paper feeding unit configured to supply a continuous paper and a digital printing unit configured to perform printing on the continuous paper supplied from the paper feeding unit;
a continuous paper guide unit configured to cause printing-completed continuous papers fed from the plurality of digital printing devices and each having different content printed thereon to be overlapped such that width direction edges of the printing-completed continuous papers are aligned, thereby forming a single continuous paper group; and
a single folding unit configured such that the single continuous paper group is guided into the single folding unit to produce a signature.

2. A method of producing a digital printing signature, the method configured to produce a signature by a plurality of digital printing devices, each of the digital printing devices comprising a folding unit and a digital printing unit, the method comprising:
guiding continuous papers individually into each of the plurality of digital printing devices to print different content on each of the guided continuous papers by each of the digital printing devices;
overlapping a plurality of printing-completed continuous papers such that width direction edges of the printing-completed continuous papers are aligned; and
guiding the overlapped plurality of printing-completed continuous papers into the folding unit to undergo cutting and folding.
